(19) United States
(12) Patent Application Publication
(10) Pub. No.: US 2026/0023283 A1
(43) Pub. Date: Jan. 22, 2026

(54) LIGHT EMITTING APPARATUS

(71) Applicant: SEOUL SEMICONDUCTOR CO., LTD., Ansan-si (KR)

(72) Inventor: Jaeeun PARK, Ansan-si (KR)

(21) Appl. No.: 19/269,828

(22) Filed: Jul. 15, 2025

Related U.S. Application Data
(60) Provisional application No. 63/672,630, filed on Jul. 17, 2024.

(51) Int. Cl. G02F 1/1335; G02F 1/13357

(52) U.S. Cl. CPC G02F 1/133607; G02F 1/133603; G02F 1/133605; G02F 1/133611; G02F 1/133608

(57) ABSTRACT

A light emitting apparatus is provided to include a frame and a light emitting module disposed on the frame. The light emitting module includes a printed circuit board (PCB), light sources disposed on the PCB, a plurality of lenses disposed on the light sources, and a reflective sheet disposed on the PCB and including a plurality of holes configured to expose the light sources. A light is emitted from the light emitting module to a display region including a central region, a vertex region, a first intermediate region between the central region and the vertex region, and the first intermediate region has a first luminance lower than a second luminance in the central region of the display region.

### PRIORITY CLAIM AND CROSS-REFERENCE TO RELATED APPLICATIONS

The present document claims priority to and the benefit of U.S. Provisional Application No. 63/672,630, filed on Jul. 17, 2024. The entire contents of which are incorporated herein by reference in its entirety.

### TECHNICAL FIELD

Various implementations of the disclosed technology relate to a light emitting apparatus, more particularly to a display apparatus including a light emitting unit.

### BACKGROUND

With the development of information society, demand for display devices is also increasing in various forms and various display devices, such as Liquid Crystal Displays (LCDs), Plasma Display Panels (PDPs), Electroluminescent Displays (ELDs), Vacuum Fluorescent Displays (VFDs), or others, have been researched and used in recent years.

Among these display devices, a display panel of an LCD includes a liquid crystal layer, a TFT substrate, and a color filter substrate disposed to face the TFT substrate, with the liquid crystal layer interposed therebetween, and can display an image using light emitted from a light emitting diode of a backlight unit.

A light emitting diode is an inorganic semiconductor device that emits light generated through recombination of electrons and holes. Light emitting diodes are rapidly replacing conventional light sources due to various advantages thereof including longer lifespan, lower power consumption, and faster response time.

### SUMMARY

Embodiments of the disclosed technology may provide a light emitting apparatus that emits light with uniform luminance.

Embodiments of the disclosed technology may provide a light emitting apparatus that is designed to consume only a suitable amount of energy while maintaining luminance uniformity at a certain level or more, thereby improving energy efficiency.

Embodiments of the disclosed technology may provide a light emitting apparatus capable of improving heat dissipation efficiency and light extraction efficiency.

Embodiments of the disclosed technology may provide a display apparatus having uniform luminance in each region of a display region and enabling color representation of an image without distortion to have high image quality.

Embodiments of the disclosed technology may provide a light emitting apparatus having a stable structure.

In one aspect, a light emitting apparatus, comprising: a frame; and a light emitting module disposed on the frame, wherein the light emitting module including a printed circuit board (PCB), light sources disposed on the PCB, a plurality of lenses disposed on the light sources, and a reflective sheet disposed on the PCB and including a plurality of holes configured to expose the light sources, wherein a light is emitted from the light emitting module to a display region including a central region, a vertex region, a first intermediate region between the central region and the vertex region, wherein the first intermediate region has a first luminance lower than a second luminance in the central region of the display region.

In some implementations, the first luminance may have a value in a range of 0.7 times to 0.9 times the second luminance. In some implementations, the first luminance may have a higher value than a third luminance in the vertex region. In some implementations, the display region may further include a second intermediate region between a side of the display region and the central region of the display region, and the second intermediate region may have a fourth luminance lower than the second luminance in the central region of the display region.

In some implementations, the fourth luminance may have a value in a range of 0.7 times to 0.9 times the second luminance. In some implementations, the fourth luminance has a higher value than a third luminance in the vertex region. In some implementations, at least one of distances between two adjacent ones of the light sources may be different from remaining distances. In some implementations, at least one of the plurality of holes may have a different size from remaining holes. In some implementations, the reflective sheet may include a plurality of punching holes, at least one of the plurality of punching holes having a different size from remaining punching holes. In some implementations, the light emitting module may further comprise a black printing layer disposed in a region on an upper surface of the PCB.

In another aspect, a light emitting apparatus is provided to comprise: a frame; and a light emitting module disposed on the frame, wherein the light emitting module including a printed circuit board (PCB), a plurality of light sources disposed on the PCB, a plurality of lenses coupled to the plurality of light sources, a reflective sheet disposed on the PCB and including a plurality of holes configured to expose the plurality of light sources; and a display region configured to receive light emitted from the light emitting module, wherein the display region has a long side in a first direction and a short side in a second direction perpendicular to the first direction, and the plurality of lenses have a short axis in a direction parallel to the first direction and a long axis in a direction parallel to the second direction.

In some implementations, a length of a lens of the plurality of lenses along the long axis may be greater than or substantially equal to twice a length of the lens along the short axis. In some implementations, at least one of the plurality of lenses may have a depression region that is substantially bisymmetrically with respect to a center line of the at least one of the plurality of lenses. In some implementations, the depression region may have a region with an inclination that gradually decreases as a distance from the center line increases. In some implementations, the display region may include a central region, a vertex region, a first intermediate region between the central region and the vertex region, and wherein the first intermediate region may have a first luminance lower than a second luminance in the central region of the display region. In some implementations, the display region may further include a second intermediate region between a side of the display region and a central region of the display region and the second intermediate region has a fourth luminance lower than a second luminance in the central region of the display region.

In another aspect, a light emitting apparatus is provided to comprise: a frame; a light emitting module disposed on the frame, wherein the light emitting module including a PCB, a plurality of light sources disposed on the PCB, a plurality of lenses disposed on the plurality of light sources, and a reflective sheet disposed on the PCB and having a plurality of holes configured to expose the plurality of light sources; and a display region configured to receive light emitted from the light emitting module, wherein the display region has a long side in a first direction and a short side in a second direction crossing the first direction, and wherein the plurality of lenses includes a reflective surface having an inclination that gradually decreases as a distance from a center of a lens increases.

In some implementations, at least one of the plurality of lenses may include a depression region disposed on a central region of the lens. In some implementations, the reflective surface and the depression region may be substantially bisymmetrical with respect to the center of the lens. In some implementations, an outer peripheral region of the depression region may include a planar surface.

Embodiments of the disclosed technology provide a light emitting apparatus that emits light with uniform luminance.

Embodiments of the disclosed technology may provide a light emitting apparatus that is designed to consume only a suitable amount of energy while maintaining luminance uniformity at a certain level or more, thereby improving energy efficiency.

Embodiments of the disclosed technology may provide a light emitting apparatus capable of improving heat dissipation efficiency and light extraction efficiency.

Embodiments of the disclosed technology may provide a display apparatus having uniform luminance in each region of a display region and enabling color representation of an image without distortion to have high image quality.

Embodiments of the disclosed technology may provide a light emitting apparatus having a stable structure.

### BRIEF DESCRIPTION OF DRAWINGS

FIG. 1 is a plan view of a display region of a light emitting apparatus according to one embodiment of the disclosed technology.

FIG. 2A is a graph depicting relative luminance depending upon a relative distance in the display region of FIG. 1 in a longitudinal direction (long axis) thereof. FIG. 2B is a graph depicting relative luminance depending upon a relative distance in the display region of FIG. 1 in a transverse direction (short axis) thereof. FIG. 2C is a graph depicting relative luminance depending upon a relative distance in the display region in the longitudinal direction (long axis) and the transverse direction (short axis) thereof.

FIG. 3 is a plan view of a light emitting unit shown in FIG. 1 based on some implementations of the disclosed technology.

FIG. 4 is a graph depicting relative luminance of one light emitting unit of FIG. 3 depending upon a relative distance of the display region in the transverse direction (short axis) thereof.

FIG. 5 is a partially enlarged view of the light emitting unit of FIG. 3.

FIG. 6 is an enlarged view of lenses in the light emitting unit of FIG. 3.

FIG. 7 is a graph depicting variation of a central distance between light sources disposed in the light emitting unit of FIG. 3.

FIG. 8 is an enlarged view of a black coating layer on one surface of a PCB of the light emitting unit of FIG. 3.

FIG. 9 is a view of a modification of the light emitting unit of FIG. 3 based on some implementations of the disclosed technology.

FIG. 10A to FIG. 10D are a cross-sectional view, a top view, a side view, and a bottom view illustrating one example of lenses disposed in the light emitting unit of FIG. 3.

FIG. 11 is a view of a modification of the lens shown in FIG. 10B based on some implementations of the disclosed technology.

FIG. 12 to FIG. 16 are cross-sectional views illustrating other examples of lenses disposed in the light emitting unit of FIG. 3.

### DETAILED DESCRIPTION

In the following description, for the purposes of explanation, numerous specific details are set forth in order to provide thorough understanding of various exemplary embodiments or implementations of the present disclosure. As used herein, “embodiments” and “implementations” are interchangeable terms for non-limiting examples of devices or methods employing one or more of the inventive concepts disclosed herein. It will be apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects (hereinafter individually or collectively referred to as “elements”) of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, and property of the elements, unless specified. Further, in the accompanying drawings, the size and relative sizes of elements may be exaggerated for clarity and/or descriptive purposes. When an exemplary embodiment is implemented differently, a specific process order may be performed differently from the described order. For example, two consecutively described processes may be performed substantially at the same time or performed in an order opposite the described order. In addition, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the DR1-axis, the DR2-axis, and the DR3-axis are not limited to three axes of a rectangular coordinate system, such as the x, y, and z-axes, and may be interpreted in a broader sense. For example, the DR1-axis, the DR2-axis, and the DR3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” and the like may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (for example, as in “sidewall”), and the like, may be used herein for descriptive purposes, and, thereby, to describe one element's relationship to other element(s) as shown in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (for example, rotated 90 degrees or at other orientations), and, as such, the spatially relative descriptors used herein may likewise interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions shown in the drawings may be schematic in nature and the shapes of these regions may not reflect actual shapes of regions of a device and, as such, are not necessarily intended to be limiting.

As customary in the field, some exemplary embodiments are described and shown in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (for example, microcode) to perform various functions discussed herein and may optionally be driven by firmware and/or software. It is also contemplated that each block, unit, and/or module may be implemented by dedicated hardware, or as a combination of dedicated hardware to perform some functions and a processor (for example, one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure pertains. Terms, such as those defined in commonly used dictionaries, should be interpreted as having a meaning that is consistent with their meaning in the context of the relevant art and should not be interpreted in an idealized or overly formal sense, unless expressly so defined herein.

In providing a display device utilizing light emitting diodes, several to dozens of light emitting diodes may be utilized. Thus, in the use of many light emitting diodes, it is very important to ensure that light emitted from the light emitting diodes uniformly reaches display regions of the display device to ensure luminance uniformity in the display region. Some implementations of the disclosed technology provide a light emitting apparatus that emits light with uniform luminance.

The disclosed technology provides a light emitting apparatus 10 including a frame 110 and a light emitting unit 120 disposed on the frame 110. Hereinafter, exemplary embodiments of the disclosed technology will be described in more detail with reference to the accompanying drawings.

The light emitting apparatus 10 may be a display device, which may be a liquid crystal display (LCD), a plasma display panel (PDP), a field emission display (FED), or an organic light emitting display (OLED), without being limited thereto. Alternatively, the light emitting apparatus 10 may be a sheet-light emitting apparatus, such as a ceiling lamp, a luminaire, a street lamp, or others.

The light emitting apparatus 10 may have a display region A on one surface thereof. The display region A may include a display panel, a panel guide, and a backlight unit. In addition, the display device of the present embodiment may further include a top cover that covers an upper edge of the display panel and is combined with the backlight unit. The display panel may include a thin film transistor substrate, a color filter substrate, and a liquid crystal layer interposed between the thin film transistor substrate and the color filter substrate, which are bonded to be opposite to one another and maintain a uniform cell gap. A driver board that supplies driving signals to gate lines and data lines may be positioned at the edge of the display panel. The driver board is electrically connected to the display panel by at least one of a COF (Chip On Film) or a TCP (Tape Carrier Package).

The backlight unit may include optical sheets, a cover, and a light emitting module. The cover may have an open upper surface, and may store the light emitting unit 120 and the optical sheets inside it. The optical sheets may include at least one of a diffusion sheet, a light collection sheet, or a protection sheet. The optical sheets may include a sheet each or plural sheets of the diffusion sheets, the light collection sheets, and the protection sheets, respectively, or may include a sheet or plural sheets of at least one of the diffusion sheets, the light collection sheets, or the protection sheets. For example, the optical sheets may be configured with a diffusion sheet and two light collection sheets, or may be configured with two diffusion sheets and a light collection sheet.

The optical sheets may be disposed parallel to the light emitting unit 120. Furthermore, the optical sheet may be disposed parallel to a side surface of the light emitting unit 120 or the PCB 122 is a substrate on which the light sources 124 are mounted, and may be a strap-type substrate

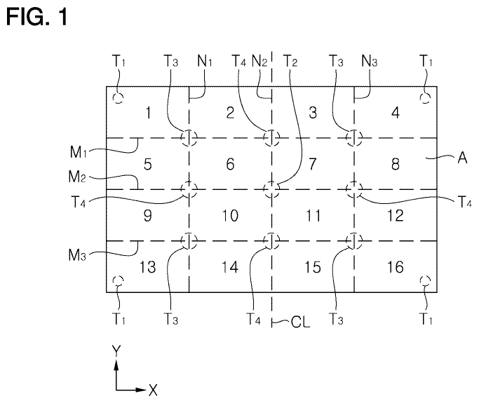

The display region A refers to a rectangular region having lengths in longitudinal and transverse directions, in which the longitudinal direction may correspond to the X-axis direction and the transverse direction may correspond to the Y-axis direction with reference to FIG. 1.

By way of example, the display region A may be a rectangular region with a long side in a first direction corresponding to the longitudinal direction (X-axis direction) and a short side in a second direction perpendicular to the first direction and corresponding to the transverse direction (Y-axis direction). The ratio of the long side to the short side may be 4:3, 13:7, 16:9, 16.7:9, 18:9, 21:9, 1.33:1, 1.85:1, 2.2:1, 2.35:1, or others, thereby realizing a display apparatus capable of expressing an image without distortion.

The display region A refers to a region from which light is emitted, and may be configured to emit light with uniform luminance over the entire region.

While luminance at a center of the display region A has a higher value than luminance at an edge thereof, if a difference between the luminance at the center and the luminance at the edge becomes too large, the deterioration in image quality is caused. Thus, it is necessary to ensure luminance uniformity in the display region A.

Luminance in a vertex region T1 of the display region A of the light emitting apparatus 10 may be defined as a first luminance A1, luminance in a central region T2 of the display region A may be defined as a second luminance A2, luminance in a first intermediate region T3 between the vertex region T1 and the central region T2 of the display region A may be defined as a third luminance A3, and luminance in a second intermediate region T4 between a side (long side or short side) of the display region A and the central region T2 may be defined as a fourth luminance A4.

Here, the first luminance A1 may have a lower value than the second luminance A2. For example, the first luminance A1 may have a value in the range of 0.4 times to 0.7 times the second luminance A2. More preferably, the first luminance A1 has a value in the range of 0.5 times to 0.6 times the second luminance A2. Such luminance settings can mitigate luminance deviation between regions within the display region A and can provide more uniform visual perception over the entire display region A.

In addition, the third luminance A3 may have a lower value than the second luminance A2 in the central region. For example, the third luminance A3 may have a value in the range of 0.7 times to 0.9 times the second luminance A2. Here, the third luminance A3 may have a higher value than the first luminance A1 in the vertex region T1 of the display region A. The third luminance A3 may have a value greater than the first luminance A1 and less than the second luminance A2. Such luminance settings can mitigate luminance deviation between the central region and a corner region and can provide uniform visual perception.

Further, the fourth luminance A4 may have a value in the range of 0.7 times to 0.9 times the second luminance A2. Here, the fourth luminance A4 may have a higher value than the first luminance A1 in the vertex region T1 of the display region A. Such luminance settings can mitigate the luminance deviation between the central region and the corner region and can provide uniform visual perception.

The light emitting apparatus 10 may be designed to maintain image quality by maintaining the luminance in the display region A of the light emitting apparatus 10 at a certain level or more while maintaining the luminance deviation in each region within a certain range (that is, maintaining luminance uniformity at a certain level or more) and to consume only a suitable amount of energy, thereby realizing high energy efficiency.

Specifically, referring to FIG. 1, when defining three dividing lines N1, N2, N3, M1, M2, M3 that divide the display region A into four equal proportions in each of the long side and short side directions, the display region A may be divided into a total of 16 regions 1 to 16. N1 to N3 are three dividing lines that divide the display region A into four equal regions on the long side, and M1 to M3 are three dividing lines that divide the display region A into four equal regions on the short side.

Referring to FIG. 1, each of the regions divided by the dividing lines N1 to N3, M1 to M3 from an upper left vertex region (first region) to a lower left vertex region (sixteenth region) may be labeled 1 to 16 as sequential first to sixteenth regions, respectively.

First, a region T1 refers to the vertex region of the display region A and may be positioned within the first, fourth, thirteenth, and sixteenth regions. The first luminance A1 may be measured in the region T1. For example, the region T1 may be an outwardly biased region in the display region A among the first, fourth, thirteenth, and sixteenth regions, and may be adjacent to the vertex.

Next, a region T2 refers to the central region of the display region A and may be positioned within the sixth, seventh, tenth, and eleventh regions of the display region A. The second luminance A2 may be measured in the region T2. For example, the region T2 may be a region corresponding to a point where the sixth, seventh, tenth, and eleventh regions meet, that is, an intersection of the central dividing lines N2, M2 on each of the long and short sides, and may be adjacent to the center of the display region A.

Next, a region T3 refers to the first intermediate region between the region T1 and the region T2 and may be positioned between the central region and the vertex region of the display region A. The third luminance A3 may be measured in the region T3. For example, the region T3 may be a region where the two dividing lines N1, N3 at both sides of the dividing line N2 passing through the center of the display region A among the three dividing lines N1 to N3 dividing the display region A into four equal regions on the long side intersect the two dividing lines M1, M3 at both sides of the dividing line M2 passing through the center of the display region A among the three dividing lines M1 to M3 dividing the display region A into four equal regions on the short side. That is, the region T3 may be positioned at an intersection of the dividing lines N1, N3 and M1, M3.

Next, a region T4 refers to the second intermediate region between a side (long side or short side) of the display region A and the central region T2 and may be positioned between the central region and the a side of the display region A. The fourth luminance A4 may be measured in the region T4. For example, the region T4 may be positioned at an intersection of the two dividing lines N1, N3 at both sides of the dividing line N2 passing through the center of the display region A among the three dividing lines N1 to N3, which divide the display region A into four equal regions on the long side, and the dividing line M2 passing through the center of the display region A among the three dividing lines M1 to M3, which divide the display region A into four equal regions on the short side. Similarly, the region T4 may be positioned at an intersection of the two dividing lines M1, M3 at both sides of the dividing line M2 passing through the center of the display region A among the three dividing lines M1 to M3, which divide the display region A into four equal regions on the short side, and the dividing line N2 passing through the center of the display region A among the three dividing lines N1 to N3, which divide the display region A into four equal regions on the long side.

Here, the third luminance A3 measured in the region T3 may have a value greater than the first luminance A1 and less than the second luminance A2. For example, the third luminance A3 may have a value in the range of 0.7 times to 0.9 times the second luminance A2, preferably 0.75 times to 0.85 times the second luminance A2. Alternatively, the third luminance A3 may be in the range of 1.75 times to 1.29 times, preferably 1.5 times to 1.42 times the first luminance A1. As a result, the light emitting apparatus 10 can use only a suitable amount of energy while maintaining image quality by maintaining the luminance within a certain range, thereby realizing high energy efficiency.

The fourth luminance A4 measured in the region T4 may have a value greater than the first luminance A1 and less than the second luminance A2. For example, the fourth luminance A4 may have a value in the range of 0.7 times to 0.9 times, preferably 0.75 times to 0.85 times the second luminance A2. Alternatively, the fourth luminance A4 may be in the range of 1.75 times to 1.29 times, preferably 1.5 times to 1.42 times the first luminance A1. As a result, the light emitting apparatus 10 can use only a suitable amount of energy while maintaining image quality by maintaining the luminance within a certain range, thereby realizing high energy efficiency.

According to the disclosed technology, the light emitting apparatus 10 is designed to use only a suitable amount of energy while maintaining image quality by maintaining the luminance deviation in each area within a certain range, thereby realizing high energy efficiency.

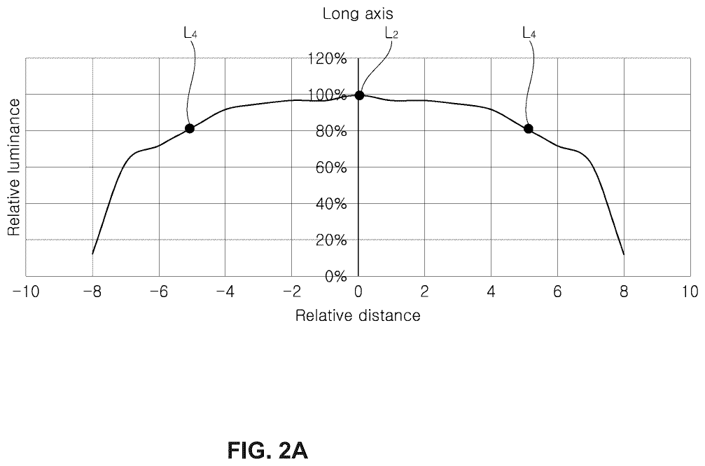

Referring to FIG. 2A, which is a graph depicting relative luminance depending upon the relative distance from the center (relative distance: 0) to an edge of the display region A in the longitudinal direction (long axis) of the display region A, it can be seen that the relative luminance gradually decreases from the center to the edge in the longitudinal direction.

The relative luminance in the central region in the longitudinal direction (long axis) of FIG. 2A is L2, which may be a relative luminance in the region T2 of FIG. 1. The region T2 refers to the central region of the display region A and may be positioned within the sixth, seventh, tenth, and eleventh regions of the display region A. For example, the region T2 may be a region corresponding to a point where the sixth, seventh, tenth, and eleventh regions meet, that is, a region corresponding to an intersection of the central dividing lines N2, M2 on each of the long and short sides, and may be adjacent to the center of the display region A.

Here, L2 denotes a relative luminance, which may have the highest value in the longitudinal direction (long axis). As such, the light emitting apparatus 10 is designed such that the central region of the display region A has a high luminance, thereby allowing a user to perceive the overall brightness of the light emitting apparatus 10 as being relatively bright even with a small number of light sources 124.

In addition, the relative luminance in an intermediate region between the central region and the edge region in the longitudinal direction (long axis) of FIG. 2A may be L4, which may be a relative luminance in the region T4 of FIG. 1. The region T4 refers to a second intermediate region between the long side of the display region A and the central region T2 and may be positioned between the central region and a side of the display region A. For example, the region T4 may be positioned at an intersection of the two dividing lines N1, N3 at both sides of the dividing line N2 passing through the center of the display region A among the three dividing lines N1 to N3, which divide the display region A into four equal regions on the long side, and the dividing line M2 passing through the center of the display region A among the three dividing lines M1 to M3, which divide the display region A into four equal regions on the short side.

The relative luminance L4 may have a smaller value than the relative luminance L2.

For example, the relative luminance L4 may have a value in the range of 70% and 90%, preferably 75% to 85%, of the relative luminance L2. Here, when the relative distance in the longitudinal direction is in a negative direction (−X axis direction) and a positive direction (+X axis direction) relative to the center (relative distance: 0), the relative luminances L4 in the region T4 may have similar values, whereby luminance uniformity of the light emitting apparatus 10 can be improved.

Similarly, referring to FIG. 2B, which is a graph depicting relative luminance depending upon the relative distance from the center (relative distance: 0) to an edge of the display region A in the transverse direction (short axis) of the display region A, it can be seen that the relative luminance gradually decreases from the center to the edge in the transverse direction.

The relative luminance in the central region in the transverse direction (short axis) of FIG. 2B is L2, which may be a relative luminance in the region T2 of FIG. 1. The region T2 refers to the central region of the display region A and may be positioned within the sixth, seventh, tenth, and eleventh regions of the display region A. For example, the region T2 may be a region corresponding to a point where the sixth, seventh, tenth, and eleventh regions meet, that is, a region corresponding to an intersection of the central dividing lines N2, M2 on each of the long and short sides, and may be adjacent to the center of the display region A.

Here, L2 denotes a relative luminance, which may have the highest luminance value in the transverse direction. As such, the light emitting apparatus 10 is designed such that the central region of the display region A has a high luminance, thereby allowing a user to perceive the overall brightness of the light emitting apparatus 10 as being relatively bright even with a small number of light sources 124.

In addition, the relative luminance in an intermediate region between the central region and the edge region in the transverse direction (short axis) of FIG. 2B may be L4, which may be a relative luminance in the region T4 of FIG. 1. The region T4 refers to the second intermediate region between the short side of the display region A and the central region T2 and may be positioned between the central region and a side of the display region A. For example, the region T4 may be positioned at an intersection of the two dividing lines M1, M3 at both sides of the dividing line M2 passing through the center of the display region A among the three dividing lines M1 to M3, which divide the display region A into four equal regions on the short side, and the dividing line N2 passing through the center of the display region A among the three dividing lines N1 to N3, which divide the display region A into four equal regions on the long side.

The relative luminance L4 may have a smaller value than the relative luminance L2.

For example, the relative luminance L4 may have a value in the range of 70% and 90%, preferably 75% to 85%, of the relative luminance L2. By maintaining the luminance in the region T4 at a certain level or more, it is possible to improve luminance uniformity of the light emitting apparatus 10.

In addition, when the relative distance in the transverse direction is in a negative direction (−Y axis direction) and a positive direction (+Y axis direction) relative to the center (relative distance: 0), the relative luminances L4 may have similar values, whereby luminance uniformity of the light emitting apparatus 10 can be improved.

Referring to FIG. 2C, which is a graph depicting relative luminance depending upon the relative distance in the longitudinal direction (long axis) and the transverse direction (short axis) of the display region A, it can be seen that the relative luminance gradually decreases from the central region of the display region A to edge regions thereof in the longitudinal direction and the transverse direction.

Here, the display region A may have the highest luminance in the central region and may have the relative luminance L2. Among the edge regions of the display region A, the vertex region may have the relative luminance L1 that is lower than the relative luminance in the central region.

The relative luminance L1 may have a value in the range of 40% to 70%, preferably 50% to 60%, of the relative luminance L2 in the central region. By maintaining the luminance in the display region A at a certain level or more, it is possible to improve luminance uniformity of the light emitting apparatus 10.

In addition, referring to FIG. 2C, the relative luminance in the region T4 is L4, which may have a smaller value than the highest luminance L2 in the central region of the display region A. The relative luminance L4 may have a value greater than the relative luminance L1 and less than the relative luminance L2.

For example, L4 may have a value in the range of 70% to 80%, preferably 75% to 85%, of L2. By managing luminance deviation in each region within the display region A within a certain ratio, it is possible to improve luminance uniformity of the light emitting apparatus 10.

Alternatively, the relative luminance L4 may have a value in the range of 1.75 times to 1.29 times, preferably 1.5 times to 1.42 times, the relative luminance L1. By increasing the relative luminance of a main light exit surface relative to the vertex region in the region T4, the light emitting apparatus 10 may be designed to use only a suitable amount of energy while maintaining image quality, thereby realizing high energy efficiency.

In addition, referring to FIG. 2C, the relative luminance in the region T3 may have a lower value L3 than the highest luminance L2 in the central region of the display region A. The relative luminance L3 may have a value greater than the relative luminance L1 and less than the relative luminance L2.

For example, the relative luminance L3 may have a value in the range of 70% and 80%, preferably 75% to 85%, of the relative luminance L2.

In some implementations, the relative luminance L3 may have a value in the range of 1.75 times to 1.29 times, preferably 1.5 times to 1.42 times, the relative luminance L1. By increasing the relative luminance of the main light exit surface relative to the vertex region in the region T4, the light emitting apparatus 10 may be designed to use only a suitable amount of energy while maintaining image quality, thereby realizing high energy efficiency.

The frame 110 may be coupled to a back cover that constitutes a rear surface of the light emitting apparatus 10. The back cover refers to a covering member that protects interior components of the light emitting apparatus 10 and may have various configurations.

The frame 110 may serve to support the components of the light emitting apparatus 10, and more specifically, the light emitting unit 120 may be coupled thereto. The frame 110 may be formed of a metallic material, such as an aluminum alloy or others, without being limited thereto.

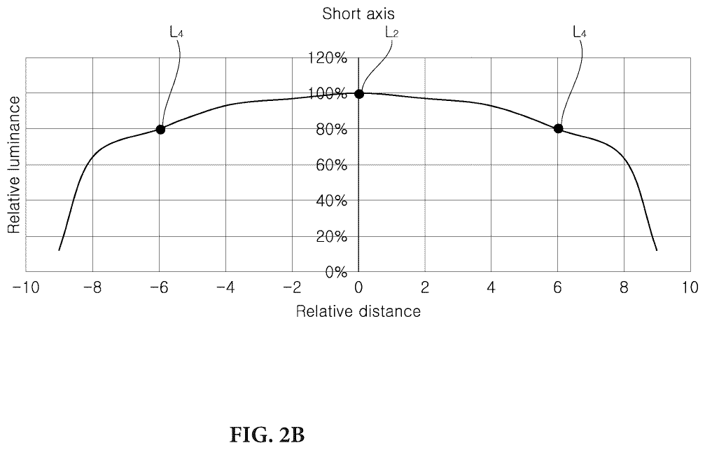

As shown in FIG. 3, the frame 110 may be divided into first and second frame regions 110a, 110b, 110c. The first frame region 110a may correspond to a central region of the frame 110 and may constitute a lower surface of the frame 110. The first frame region 110a may be a flat surface.

The second frame regions 110b, 110c may correspond to outer peripheral regions of the frame 110 and may constitute inclined walls or vertical walls that define the depth of the frame 110. The second frame regions 110b, 110c act as sidewalls of the frame 110 and may form a mounting surface through which a PCB 122 is mounted on the first frame region 110a. When the PCB 122 is mounted on a flat surface, it is possible to increase heat dissipation efficiency by minimizing a distance from the lower surface.

The light emitting apparatus 10 may further include a third frame region in the form of a flange extending from the second frame regions 110b, 110c in a horizontal direction. The third flange region formed in the flange shape may reflect light, which is emitted and lost through a side surface, towards a front side to improve light extraction efficiency.

The frame 110 may be coupled to a reflective sheet 128 described below. The reflective sheet may reflect light, which reenters the bottom surface and is absorbed thereby, back to a front side to improve light extraction efficiency. Here, corresponding to the shape of the frame, the reflective sheet 128 may have a flat surface in the first frame region 110a and a flange shape in the second frame regions 110b, 110c. The reflective sheet 128 may have cut surfaces in the frame regions 100a, 110b, 110c and may be bonded to the frame 110 through the cut surfaces to minimize a gap between the frame 110 and the reflective sheet 128, whereby a reflective surface of the reflective sheet 128 can have uniform flatness, thereby improving luminance of the light emitting apparatus 10. Here, the cut surface of the second frame region 110b, 110c may be spaced apart from the centerline CL. An extension of the cut surface of the second frame region 110b, 110c may not pass through the centerline CL. This structure can reduce light degradation in the central region.

The light emitting unit 120 is a light source unit secured to the frame 110 and may have various configurations.

The light emitting unit 120 is a light source unit placed on the rear side of a panel of the light emitting apparatus 10 and may include a plurality of light sources 124. The light emitting unit 120 may be a direct backlight unit or a surface-light emitting unit of a ceiling luminaire.

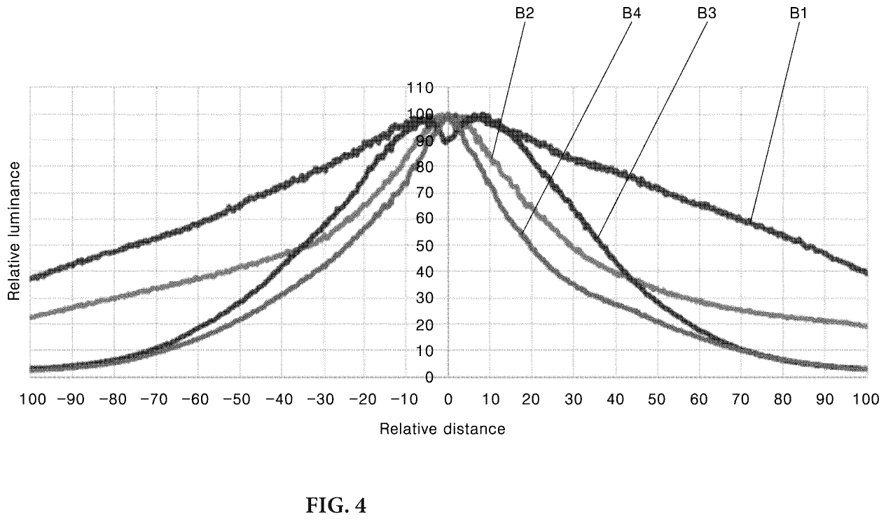

Specifically, the light emitting unit 120 may include a PCB 122, a plurality of light sources 124 mounted on the PCB, a plurality of lenses 126 coupled to the light sources 124, respectively, and a reflective sheet 128 covering the PCB 122 and having a plurality of holes 128a open to expose the plurality of lenses 126. Although the holes 128a formed on the reflective sheet 128 are omitted in FIG. 3 for clear illustration of other configurations, the holes 128a through which the lenses 126 are exposed to the reflective sheet 128 are clearly shown in FIG. 6.

The PCB 122 is a substrate on which the light sources 124 are mounted, and may be a strap-type substrate extending in the horizontal direction (X-axis direction) of the display region A and having a width in the transverse direction (Y-axis direction). Here, the ratio of the long side to the short side of the PCB 122 may have various ratios, such as 4:3, 13:7, 16:9, 16.7:9, 18:9, 21:9, 1.33:1, 1.85:1. 2.2:1, 2.35:1, or others, so as to realize a display apparatus capable of expressing an image without distortion.

One surface of the PCB 122 acts as a mounting surface, on which a plurality of light sources 124 may be mounted. The PCB 122 may be formed on one surface thereof with an electrode pattern for electrical connection to the light sources 124.

The PCB 122 may be formed of or include an insulating material, such as polyethylene terephthalate (PET), glass, polycarbonate (PC), and silicone, or a metallic material, such as aluminum, copper, or others.

The plurality of light sources 124 may be mounted on the one surface of the PCB.

Each of the light sources 124 may be a light emitting diode (LED) chip or a light emitting diode package including at least one light emitting diode chip.

For example, the light source 124 may include a substrate and a light emitting structure grown on the substrate.

The substrate refers to a substrate on which a semiconductor layer is disposed, and is selected from or implemented as any substrates on which nitride semiconductors can be disposed.

For example, the substrate may include a heterogeneous substrate, such as a sapphire substrate, a gallium arsenide substrate, a silicon substrate, a silicon carbide substrate, or a spinel substrate, and may also include a homogeneous substrate, such as a gallium nitride substrate, an aluminum nitride substrate, or others.

The light emitting structure refers to a semiconductor layer grown on the substrate, and may include a first conductivity type semiconductor layer, an active layer, and a second conductivity type semiconductor layer.

The first conductivity type semiconductor layer may be a semiconductor layer disposed on one surface of the substrate, and a buffer layer (not shown) may be further disposed between the first conductivity type semiconductor layer and the substrate.

The first conductivity type semiconductor layer may include a phosphide or nitride semiconductor, such as (Al, Ga, In) P or (Al, Ga, In) N, and may be disposed on the substrate by a method, such as MOCVD, MBE, HVPE, or others. In addition, the first conductivity type semiconductor layer may be doped with n-type dopants including at least one of Si, C, Ge, Sn, Te, Pb, or others. However, the first conductivity type semiconductor layer may also be doped with an opposite conductivity type dopant including p-type dopants.

In some implementations, the first conductivity type semiconductor layer may be formed in a monolayer or multilayer structure. Furthermore, the first conductivity type semiconductor layer may further include a contact layer, a modulation doping layer, an electron implantation layer, or others.

The active layer is a light emitting layer formed on the first conductivity type semiconductor layer. The active layer may include a phosphide or nitride semiconductor, such as (Al, Ga, In) P or (Al, Ga, In) N, and may be grown on the first conductivity type semiconductor layer 122 by a technique, such as MOCVD, MBE, or HVPE.

In some implementations, the active layer may include a quantum well structure (QW) including at least two barrier layers and at least one well layer, and may further include a multi-quantum well structure (MQW) including a plurality of barrier layers and a plurality of well layers.

The wavelength of light emitted from the active layer may be adjusted by controlling the composition of materials constituting the well layer. Here, the well layers may include the same element in common and may include indium (In).

The second conductivity type semiconductor layer may be a semiconductor layer formed on the active layer. The second conductivity type semiconductor layer may include a phosphide or nitride semiconductor, such as (Al, Ga, In) P or (Al, Ga, In) N, and may be grown by a technique, such as MOCVD, MBE, or HVPE. The second conductivity type semiconductor layer may be doped to have an opposite conductivity to the conductivity of the first conductivity type semiconductor layer. For example, the second conductivity type semiconductor layer may be doped with p-type dopants including magnesium (Mg).

The second conductivity type semiconductor layer may be formed as a single layer having a composition, such as p-GaN, without being limited thereto, and may further include an AlGaN layer therein.

The light source 124 may include a lower contact layer, which includes a transparent conductive material transmitting light, an insulating layer, a P-electrode pad, and an N-electrode pad.

The N, P electrode pads may be electrically connected to the PCB 122 through connection electrodes. However, it should be understood that embodiments of the disclosed technology are not limited thereto and the N, P electrode pads may be directly soldered to the PCB 122 without the connection electrodes.

In some implementations, the light source 124 may be or include a stack type semiconductor layer having a plurality of light emitting diodes stacked and disposed thereon. The stack type semiconductor layer may include a first light emitting stack, a second light emitting stack, and a third light emitting stack sequentially stacked one above another. The second light emitting stack may be formed on the first light emitting stack and the third light emitting stack may be formed on the second light emitting stack.

Each of the first to third light emitting stacks may include a first conductivity type semiconductor layer, an active layer, and a second conductivity type semiconductor layer.

The first to third light emitting stacks may be a red light emitting stack, a green light emitting stack, and a blue light emitting stack, respectively.

It should be understood that the light source 124 can be implemented in a variety of different configurations.

By way of example, the light source 124 is a diode that emits blue light (B), and may be a blue light emitting diode having a peak wavelength within the blue wavelength band. Alternatively, the light source 124 is a diode that emits green light (G), and may be a green light emitting diode having a peak wavelength within the green wavelength band. Alternatively, the light source 124 is a diode that emits red light (R), and may be a red light emitting diode having a peak wavelength within the red wavelength band, in which a difference between the peak wavelength and a dominant wavelength of the red light emitting diode may range from 5 nm and 30 nm. Specifically, the red light emitting diode may have a peak wavelength between 620 nm and 640 nm and a dominant wavelength between 600 nm and 630 nm. The peak wavelength of the red light emitting diode may be a longer wavelength than the dominant wavelength.

The plurality of light sources 124 may be spaced apart in the longitudinal direction (X-axis direction) of the PCB 122. That is, the plurality of light sources 124 may be spaced apart in the longitudinal direction (X-axis direction) of the display region A.

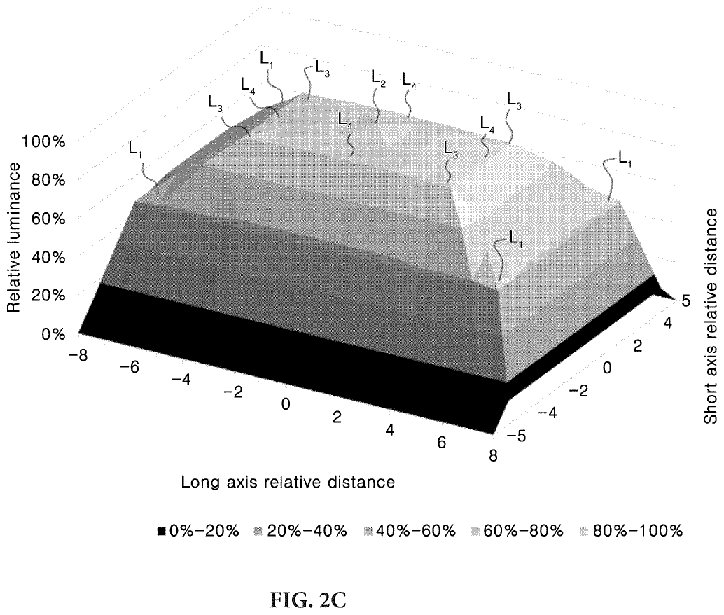

Since the longitudinal direction (X-axis direction) of the PCB 122 is perpendicular to the transverse direction (Y-axis direction) of the display region A and the plurality of light sources 124 are disposed in the longitudinal direction (X-axis direction) of the display region A, the relative luminance may gradually decrease from the center (relative distance: 0) of the display region A to the edge thereof in the transverse direction (Y-axis direction), as shown in FIG. 4. In FIG. 4, a pattern in which the relative luminance decreases may be formed in various ways from B1 to B4, which may be determined according to the configuration, arrangement, or others of the PCB 122, the light source 124, and the lens 126 constituting the light emitting unit 120.

Here, the plurality of light sources 124 may be disposed substantially symmetrically with respect to the centerline CL of the display region A in the longitudinal direction (X-axis direction) thereof.

Referring now to FIG. 6, the plurality of light sources 124 may be disposed in the longitudinal direction (X-axis direction) of the display region A to be substantially symmetrical with respect to the centerline CL of the display region A in the longitudinal direction (X-axis direction) thereof.

A central distance CD between the plurality of light sources 124 is a distance between adjacent light sources 124 and may be defined as a distance between centers of adjacent light sources 124.

Here, at least one of the central distances CDs between the plurality of light sources 124 may be different from the other central distances CDs.

The central distance CD may be variable depending on the region within the display region A. That is, the central distance CD between the plurality of light sources 124 may have different values depending on their locations in the display region A. A distance between the plurality of light sources 124 may be variable to allow light emitted from the plurality of light sources 124 to form constructive interference, thereby improving luminance uniformity.

Referring to FIG. 6, it can be seen that the central distance CD is not constant and appears uneven from the centerline CL of the display region A to an edge EG thereof.

For example, the central distance CD at the center of the display region A may be greater than the central distance CD at the edge thereof.

By making the central distance CD at the center of the display region A greater than the central distance CD at the edge thereof, it is possible to compensate for deterioration in luminance at the edge of the display region A. The central distance CD may have a minimum value at the edge of the display region A, thereby providing an effect of compensating for deterioration in luminance at the edge of the display region A.

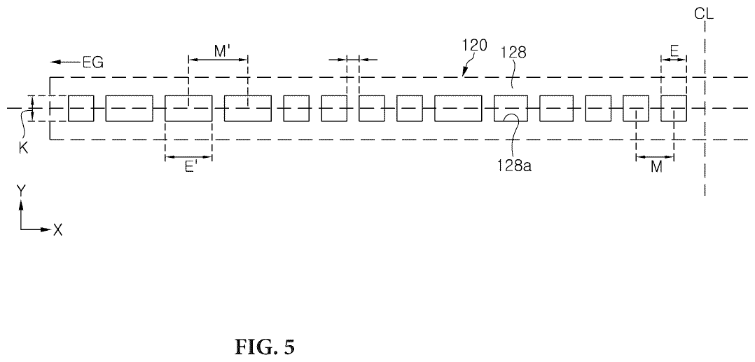

FIG. 7 is a graph depicting variation of the central distance CD between the light sources 124 from the centerline CL of the display region A to the edge EG, in which the central distance CD at the center of the display region A is greater than the central distance CD at the edge of the display region A and the central distance CD gradually decreases from the center toward the edge.

Here, the central distance CD may be varied to slightly increase and then decrease from the central region CL of the display region A to the edge region EG thereof, as shown in FIG. 7, and luminance uniformity can be improved by widening the central distance CD in a region in which more light overlaps. However, it should be understood that the disclosed technology is not limited thereto. Alternatively, the central distance CD may be varied to consistently decrease from the central region CL of the display region CL to the edge region EG thereof to prevent deterioration in luminance in the edge region EG, in which less light overlap occurs. Here, the distance between the light sources 124 in a region close to the central region CL may range from 1.65 times to 1.8 times the distance between the light sources 124 in the edge region EG. The light sources 124 may be arranged such that the largest distance between the light sources 124 ranges from 1.4 times to 1.65 times the distance between the light sources 124 in the edge region EG. In this way, luminance uniformity of the light emitting apparatus can be improved by adjusting the arrangement of the light sources 124.

A variation degree by which the central distance CD varies from the centerline CL to the edge region EG may also be made constant to match luminance uniformity at the right and left sides, or may be varied depending on the location according to the degree of light overlapping to improve luminance uniformity.

Each of the plurality of lenses 126 is an optical member coupled to a respective one of the light sources 124 and may have various configurations. For example, the lenses 126 may be anisotropic lenses.

The lens 126 may be disposed on the light source 124. That is, the light source 124 may be covered by the lens 126, with the light source 124 disposed on the PCB 122.

In some implementations, the lens 126 may be formed on a low surface 126b thereof with a recess 126h in which the light source 124 is disposed. The recess 126h is a space concavely formed upward on the lower surface 126b of the lens 126, and an inner circumferential surface of the recess 126h may serve as an incident surface 126d on which light emitted from the light source 124 is incident.

In addition, a plurality of legs 126e may be formed on a lower surface 126b of the lens 126 to support a main body of the lens 126. The legs 126e may protrude downwards (−Z direction) from the lower surface 126b of the lens 126. The legs 126e may serve to secure the lens 126 to the PCB 122 on which the light source 124 is mounted. For example, the lens 126 may be secured to the PCB 122 via a bonding agent between the leg 126e and the PCB 122, and the leg 126e may have a flat lower surface for securing. The legs 126e may have a height greater than or substantially equal to 0.5% and less than 10% of the height h of the lens 126. This structure allows easy adjustment of a light path by separating the lower surface 126b of the lens 126 from the light source 124.

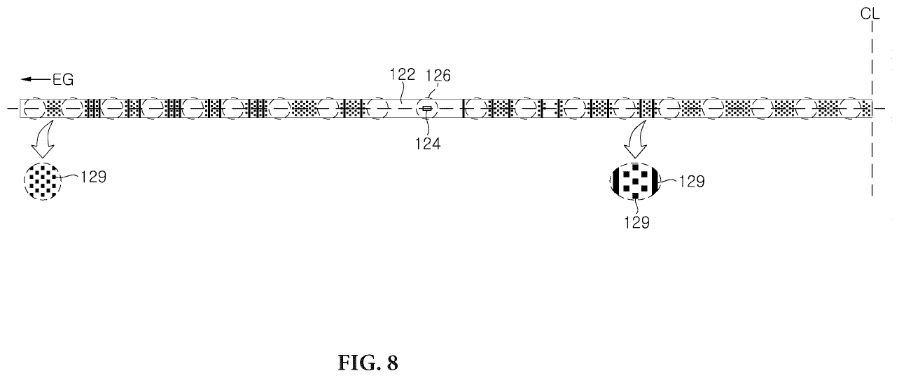

Furthermore, referring to FIG. 10D, a plurality of protrusions 126g may be formed on the lower surface 126b of the lens 126 to be disposed farther outwards than the legs 126e. The protrusions 126g may be alignment members that assist in aligning the lens 126 in place when securing the lens 126 to the PCB 122. By disposing the lens 126 such that the protrusions 126g correspond to position markers on one surface of the PCB 122, the lens 126 can be secured in place. The protrusions 126g may have a lower height than the legs 126e. The height of the protrusions 126g may range from 50% to 90% of the height of the legs 126e. This structure can prevent tilting of the lens 126. Here, the number of protrusions 126g may be the same as the number of legs 126e. This structure can improve structural stability.

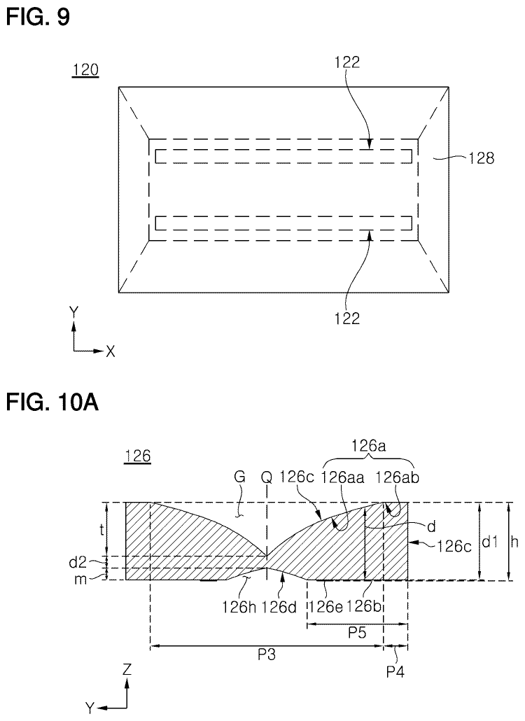

Further, referring to FIG. 10B, the lens 126 may further include a side protrusion 126f projecting outwards from a side surface thereof. The side protrusion 126f may be formed on at least one of two opposite side surfaces of the lens 126 in a lateral direction. Although FIG. 10B shows an example in which the side protrusion 126f is formed on a side surface of the lens 126, the side protrusions 126f, 126f may also be formed on both of the opposite side surfaces of the lens 126 in the lateral direction, as shown in FIG. 11. The length of the side protrusion 126f in the short axis direction (X-axis direction) may be about 5% to 20% of the length (P2) of the lens 126 in the short axis direction (X-axis direction). This structure can reduce influence of the side protrusion 126f on radiation angle while ensuring reliable visual identification.

The side protrusion 126f may be a reference mark for orientation of the lens 126. When the lens 126 includes two side protrusions 126f, 126f as shown in FIG. 11, the lens 126 may be substantially symmetrical in both the longitudinal and transverse directions, thereby enabling more uniform light diffusion. Here, the two side protrusions 126f, 126f may have similar sizes to achieve symmetry of emitted light, or may have different sizes to act as reference marks for orientation. Here, the difference in size of the two side protrusions 126f, 126f may be greater than 10% and less than 20%.

Specifically, the lens 126 may be an anisotropic lens and may include a light incidence surface 126d on which light emitted from the light source 124 is incident and a light exit surface 126c from which light having passed through the light incidence surface 126d is emitted. The light incidence surface 126d and the light exit surface 126c may be placed on different surfaces of the lens 126. Here, the depth m of the light incidence surface 126d may be less than the depth t of the light exit surface 126c. In one example, the light incidence surface 126d may have a depth m of greater than or substantially equal to 20% and less than 30% of the depth t of the light exit surface 126c.

Further, the lens 126 may include a reflective surface 126a on which light having passed through the light incidence surface 126d is refracted or reflected. The reflective surface 126a may be an upper surface of the lens 126. A part of the light incident through the light incidence surface 126d may be refracted at the reflective surface 126a and emitted to the outside, in which case the region where the light is emitted may form an emission surface 126c. Alternatively, the light incident through the light incidence surface 126d may be totally reflected at the reflective surface 126a and emitted to the outside, and in this case, the region where the light is emitted may form the emission surface 126c. In addition, a depression region G may be formed on the upper surface of the lens 126. The depression region G is a space formed concavely downward on the upper surface of the lens 126, and the reflective surface 126a and the emission surface 126c may be formed in the depression region G.

The light incidence surface 126d may be a convexly curved surface formed by the recess 126h and recessed into the body of the lens 126, and may be connected to the lower surface 126b of the lens 126. That is, the light incidence surface 126d may be surrounded by the lower surface 126b of the lens 126. The depth m of the recess 126h of the light incidence surface 126d may be smaller than the height h of the body of the lens 126. Here, the depth m of the recess 126h may range from 10% to 20% of the height h of the body of the lens 126. This structure allows sufficient light to be collected on the light incidence surface 126d. In addition, the depth m of the recess 126h of the light incidence surface 126d may be less than the depth t of the depression region G forming the reflective surface 126a. In one example, the depth m of the recess 126h of the light incidence surface 126d may be greater than or substantially equal to 20% and less than 30% of the depth t of the depression region G. This structure allows the light collected by the light incidence surface 126d to be refracted at a sufficient angle on the light exit surface 126c.

Although FIG. 10A shows that the lower surface 126b is a planar surface, it should be understood that the disclosed technology is not limited thereto and the lower surface 126b may be an inclined surface.

The lens 126 may have a long axis and a short axis in top plan view. When the display region A has a long side in a first direction and a short side in a second direction perpendicular to the first direction, the lens 126 may have a short axis in a direction parallel to the first direction and a long axis in a direction parallel to the second direction.

Further, the short axis of the lens 126 may be parallel to the longitudinal direction (X-axis direction) of the PCB 122 and the long axis of the lens 126 may be parallel to the traverse direction (Y-axis direction) of the PCB 122. Accordingly, the lens 126 may be a light diffusing lens in which light emitted from the light source 124 is diffused in the long axis direction.

The light emitted through the lens 126 may have a higher luminance at a distance spaced apart from the PCB 122 in the Y-axis direction than the luminance in the central region of the PCB 122 in the traverse direction (Y-axis direction) of the PCB 122 in the light emitting unit 120. Here, the traverse direction may be the same as the short axis direction. To this end, the light emitted through the lens 126 may have a wider beam angle than the light emitted from the light source 124. Furthermore, the light emitted through the lens 126 may have a higher luminance in one region provided with no light source 124 than in a region provided with the light source 124.

The lens 126 may have a length P1 in the long axis direction thereof and a length P2 in the short axis direction thereof. The length P1 of the lens 126 in the long axis direction may be greater than or substantially equal to twice the length P2 of the lens 126 in the short axis direction. More preferably, the length P1 is 4 times to 5 times the length P2.

Here, the light incidence surface 126d may also have a long axis and a short axis, in which the short axis of the light incidence surface 126d is parallel to the short axis of the lens 126 and the long axis of the light incidence surface 126d is parallel to the long axis of the lens 126. This structure allows an incident path of light incident on the long axis of the light incidence surface 126d to be lengthened, thereby allowing the lens 126 to have a wide beam angle along the long axis of the lens 126 in the long axis direction.

The light from the light source 124 can enter the lens 126 while being spread widely by the curved structure of the light incidence surface 126d of the recess 126h, thereby widening the beam angle while reducing light loss.

On the other hand, as shown in FIG. 10A, the lens 126 may have a depression region G formed on an upper surface thereof. The depression region G may form a depressed structure inside the body of the lens 126 from an end of the upper surface of the lens 126 to the centerline Q in the long axis direction of the lens 126. By this structure, the light path can be adjusted such that the luminance in the central region of the lens 126 in the long axial direction is lower than the luminance in a peripheral region, and luminance uniformity in the central region and the peripheral region of the light emitting apparatus 10 can be improved.

The reflective surface 126a and the light exit surface 126c may be formed by the depression region G.

The depression region G may be formed in a substantially bisymmetrical form with respect to the centerline Q of the lens 126 in the long axis direction (Y-axis direction). This structure allows adjustment of the light path such that the beam angle of light is symmetrical with respect to the center, thereby improving luminance uniformity.

The reflective surface 126a may include a convex surface constituting the depression region G, without being limited thereto. Alternatively, the reflective surface 126a may be at least partially straight, inclined, or planar, and when a planar region is formed in the depression region G, the beam angle can be widened through the planar region. The depth t of the depression region G may range from 50% to 70% of the maximum thickness d1 of the body of the lens 126. This structure secures a sufficient refractive path of light to diffuse light.

In addition, the depression region G may have a gradually decreasing inclination away from the center. Further, an outer peripheral region of the depression region G may form a planar structure.

For example, the depression region G may include a plurality of reflective surfaces 126aa, 126ab having different curvatures. The first reflective surface 126aa placed in the central region of the depression region G in the long axis direction (Y-axis direction) thereof may be an upwardly convex surface and the second reflective surface 126ab placed in the outer peripheral region of the depression region G in the long axis direction (Y-axis direction) thereof may be a planar surface. The second reflective surface 126ab may be connected to a side surface of the lens 126. The length P3 of the first reflective surface 126a in the long axis direction may range from 60% and 85% of the length P1 of the body of the lens 126 in the long axis direction. In addition, the length P4 of the second reflective surface 126ab in the long axis direction may have a shorter than the length P3 of the first reflective surface 126aa in the long axis direction. The length P4 of the second reflective surface 126ab in the long axis direction may be in the range of 15% and 30% of the length P3 of the first reflective surface 126aa in the long axis direction. This structure allows adjustment of the light path to ensure sufficient diffusion of light along the reflective surface 126a.

In addition, the first reflective surface 126aa of the depression region G may have a gradually decreasing inclination away from the centerline Q of the depression region G, and the light emission path may be adjusted such that the directional pattern of the emitted light changes gradually as an angle from the center of the lens 126 increases. This structure can increase luminance uniformity in the central region of the light emitting apparatus 10 and in regions spaced apart from the center.

The second reflective surface 126ab may be parallel to the lower surface 126b. The length P4 of the second reflective surface 126ab in the long axis direction may have a shorter than the length P5 of the lower surface 126b in the long axis direction. The length P4 of the second reflective surface 126ab in the long axis direction may range from 20% to 30% of the length P5 of the lower surface 126b in the long axis direction. This structure allows adjustment of the light path while providing a gradually decreasing inclination at a distal end of the reflective surface 126a to prevent the lens 126 from being damaged due to external impact.

Light having entered the lens 126 through the light incidence surface 126d of the recess 126h may be reflected or refracted from the reflective surface 126a and then emitted through the light exit surface 126c of the lens 126.

To improve efficiency in extraction of light from the light exit surface 126c, a reflector may be disposed in a region on the light incidence surface 126d of the recess 126h. The reflector may include a reflective material. The reflective material may include a paint containing particles, such as TiO₂, BaSO₄, or others, silicon, or a metallic material, such as aluminum, silver, or others. Alternatively, the reflector may include a stack of birefringent materials. The reflective material may be disposed in at least one region on the lower surface 126b of the lens 126.

The light exit surface 126c refers to a surface through which light is emitted from the lens 126. The lens 126 may have a side light exit surface through which light emitted from the light source 124 is emitted in the lateral direction. Although the light exit surface 126c formed on the side of the lens 126 is shown as being a vertical surface in FIG. 10A, it should be understood that the disclosed technology is not limited thereto. Alternatively, the light exit surface 126c may also have an inclined or curved surface. When the light exit surface 126c is composed of a straight region, the light emission direction can be simplified to reduce light interference.

The light exit surface 126c may be formed along a side surface of the body of the lens 126 and serves to reduce interference of side light.

The thickness d1 of the body of the lens 126 at the outer periphery of the lens 126 may be greater than the thickness d2 of the lens 126 at the centerline Q, where the thickness is measured through the depression region G and the recess 126h. In this case, the thickness d1 of the body of the lens 126 at the outer periphery may be 4 to 5 times the thickness d2 of the lens 126 at the centerline Q. This can reduce damage to the lens 126 due to external impact.

Light emitted from the light source 124 may be primarily refracted to spread in the long axis direction through the light incidence surface 126d of the lens 126, secondarily reflected through the reflective surface 126c in the long axis direction, and then emitted through the light exit surface 126a. A portion of the light may be refracted at the reflective surface 126c and emitted through the light exit surface 126a.

The shape of the lens 126 shown in FIG. 10A to FIG. 11 is exemplary and the disclosed technology is not limited thereto. The lens 126 may be formed in various shapes so long as the lens is an anisotropic lens and has the reflective surface 126a and the light exit surface 126c.

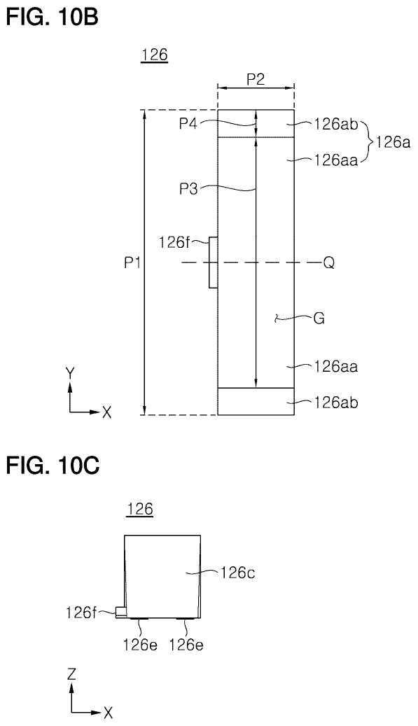

As a variant example, a lens 226 may be formed in a shape as shown in FIG. 12. Unlike the embodiments shown in FIG. 10A to FIG. 11, the lens 226 may have a depression region G′ depressed towards the centerline Q over the entire edge of the lens 226 in both the long axis direction and the short axis direction.

Here, when the lens 226 has a circular outer peripheral shape, the depression region G′ may be formed in a circular shape corresponding to the outer peripheral shape of the lens 226. The lens 226 may have a structure of a rotating body rotated about the Z-axis. When one axis perpendicular to the Z-axis is referred to as the Y-axis and an axis perpendicular to the Y-axis and the Z-axis is referred to as the X-axis, beam angles of the lens 226 in the X-axis and the Y-axis may be similar to each other, and such a structure allows light to evenly spread on a front side of the light emitting apparatus 10, thereby improving luminance uniformity of the light emitting apparatus 10.

Furthermore, a reflective surface 226a of the depression region G′ may have a gradually decreasing inclination away from the centerline Q of the depression region G′ and the inclination of the outermost region of the reflective surface 226a may be substantially parallel to a lower surface 226b of the lens. Variation in inclination of the reflective surface 226a may allow adjustment of the light path such that the directional pattern of the emitted light has a gentler inclination as the beam angle increases away from the center of the lens 226. This structure increases the luminance in a region spaced apart from the central region of the light emitting apparatus 10, thereby improving luminance uniformity in the central region and the outer peripheral region of the display region A of the light emitting apparatus 10.

In addition, the depression region G′ may have a depth t of two-thirds or more of the total height h of the lens 226, thereby enabling diffusion of light over a larger area than the size of the lens 226.

Light having entered the lens 226 through a light incidence surface 226d of a recess 226h may be reflected from the reflective surface 226a and then emitted through a light exit surface 226c of the lens 226. A portion of the light may be refracted at the reflective surface 226a and emitted through the light exit surface 226c. The height m of the light incidence surface 226d may range from 0.1 to 0.3 times the height of the lens 226. This structure allows efficient refraction of light into the lens 226.

To improve efficiency in extraction of light from the light exit surface 226c, a reflector may be disposed in a region on the light incidence surface 226d of the recess 226h. The reflector may include a reflective material. The reflective material may include a paint containing particles, such as TiO₂, BaSO₄, or others, silicon, or a metallic material, such as aluminum, silver, or others. Alternatively, the reflector may include a stack of birefringent materials or may be formed in various configurations. The reflector may be spaced apart from the reflective surface 226a.

Any one region of the light incidence surface 226d may have a higher inclination than one region of the light exit surface 226c, thereby allowing light entering the lens 226 to spread evenly inside the lens 226.

The height m of the light incidence surface 226d in the Z-axis may be less than or substantially equal to one-third of the height h of the lens 226 and may be lower than the height of the light exit surface 226c formed on the upper surface of the lens 226. This structure allows adjustment of the light path to have wider diffusion of light on the light exit surface 226c than diffusion of incident light such that the lens can have a wider beam angle than the light source 124. The height m of the light incidence surface 226d may have the highest height near the centerline Q. Here, the distance n between the light incidence surface 226d and the reflective surface 226a on the centerline Q may be the smallest distance. The thickness d of the body of the lens 226 may have a minimum value d2 on the centerline Q. Here, the distance n between the light incidence surface 226d and the reflective surface 226a may range from 15% to 30% of the highest height h of the lens 226. This structure can prevent the lens 226 from becoming too thin, thereby suppressing deformation of the lens 226 while improving structural stability.

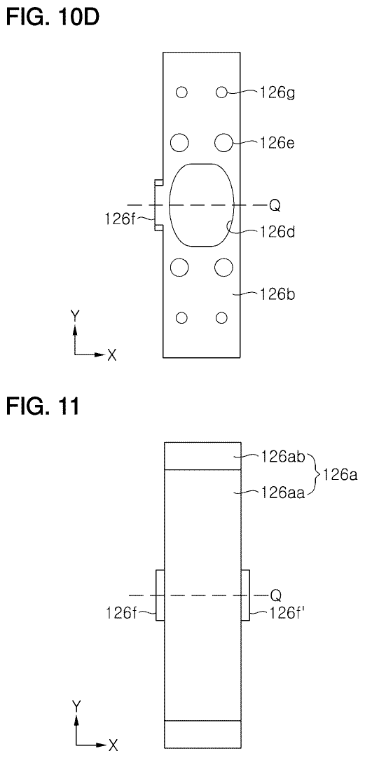

As another variant example, a lens 326 may be formed in a shape as shown in FIG. 13. Unlike the embodiments of FIG. 10A to FIG. 12, the lens 326 may include a plurality of light exit surfaces 326c formed on the side surface. Specifically, the light exit surfaces 326c of the lens 326 may include a first side light exit surface 326ca connected to a reflective surface 326a and a second side light exit surface 326cb connected to the first side light exit surface 326ca and disposed at a lower region thereof.

Although the first side light exit surface 326ca is shown as an inclined surface in FIG. 13, the first side light exit surface 326ca may be formed as a convexly or concavely curved surface. Although the second side light exit surface 326cb is also shown as a convexly curved surface, the second side light exit surface 326cb may be formed as a vertical or inclined surface.

One region of the first side light exit surface 326ca may have a higher inclination than one region of the second side light exit surface 326cb and a light path from the first side light exit surface 326ca may be different from a light path from the second side light exit surface 326cb. The first side light exit surface 326ca may have an inclination of 80° to 89° relative to a planar region of a lower surface 326b of the lens. This structure allows diffusion of light through adjustment of the light path. The second side light exit surface 326cb may also have a shape that decreases in inclination toward a center thereof. A tangent line of the second side light exit surface 326cb may have an inclination gradually decreasing with increasing distance from the lower surface 326b of the lens. A tangent line of the second side light exit surface 326cb adjacent to the lowermost portion thereof may have a higher inclination than a tangent line of the second side light exit surface 326cb adjacent to a region where the second side light exit surface 326cb meets the first side light exit surface 326ca. Here, the inclination of the tangent line of the second side light exit surface 326cb tangential to the lowermost portion thereof may be 20° to 30° greater than the inclination of the tangent line of the second side light exit surface 326cb that meets the first side light exit surface 326ca. This structure allows adjustment of the beam angle by collecting light to a certain region.

The height K1 of the first side light exit surface 326ca may be greater than the height K2 of the second side light exit surface 326cb, whereby a greater amount of light can be emitted from the first side light exit surface 326ca than from the second side light exit surface 326cb. The height K1 of the first side light exit surface 326ca may range from 1.3 times to 1.6 times the height K2 of the second side light exit surface 326cb.

In addition, the height K1 of the first side light exit surface 326ca may be less than a height t of the reflective surface 326a. The height K1 of the first side light exit surface 326ca may range from 0.6 times to 0.8 times the height t of the reflective surface 326a. With this structure, the luminance on the first side light exit surface 326ca may be higher than the luminance in the central region of the reflective surface 326a of the lens 326 and thus the luminance in the outer peripheral region may be higher than the luminance in the central region of the lens 326. Further, the height K2 of the second side light exit surface 326cb may be less than the height t of the reflective surface 326a. The height K2 of the second side light exit surface 326cb may range from 0.4 times to 0.6 times the height t of the reflective surface 326a.

The height K1 of the first side light exit surface 326ca may be greater than the height m of the light incidence surface 326d. The height K1 of the first side light exit surface 326ca may range from 2.5 times to 2.9 times the height m of the light incidence surface 326d. The height K2 of the second side light exit surface 326cb may be greater than the height m of the light incidence surface 326d. The height K2 of the second side light exit surface 326cb may range from 1.5 times to 2.1 times the height m of the light incidence surface 326d. In addition, the lowest point S1 of the reflective surface 326a may be lower than the highest point S2 of the second side light exit surface 326cb in a height direction Z from a lower surface of the lens 326. The height of the lowest point S1 of the reflective surface 326a may be at a height corresponding to 60% to 80% of the height of the highest point S2 of the second side light exit surface 326cb. This structure may allow adjustment of the light path such that light reflected from the reflective surface 326a can be emitted through the side surface of the lens.

The peripheral width W1 of the first side light exit surface 326ca may be greater than the width W3 of the light incidence surface 326d. The peripheral width W1 of the first side light exit surface 326ca may range from 1.5 times to 3 times the width W3 of the light incidence surface 326d. The peripheral width W2 of the second side light exit surface 326cb may be greater than the width W3 of the light incidence surface 326d. The peripheral width W2 of the second side light exit surface 326cb may range from 2.5 times to 3.5 times the width W3 of the light incidence surface 326d. This structure may allow light having entered the lens through the light incidence surface 326d to be emitted through the light exit surface 326c.

The peripheral width W1 of the first side light exit surface 326ca may be greater than the width W4 of the reflective surface 326a. The peripheral width W1 of the first side light exit surface 326ca may range from 1.02 times to 1.1 times the width W4 of the reflective surface 326a. The peripheral width W2 of the second side light exit surface 326cb may be greater than the width W4 of the reflective surface 326a. The peripheral width W2 of the second side light exit surface 326cb may range from 1.15 times to 1.3 times the width W4 of the reflective surface 326a. This structure allows light having entered the lens through the light incidence surface 326d to be emitted through the light exit surface 326c.

The peripheral width W1 of the first side light exit surface 326ca may be narrower than the peripheral width W2 of the second side light exit surface 326cb. The peripheral width W1 of the first side light exit surface 326ca may range from 0.7 times to 0.9 times the peripheral width W2 of the second side light exit surface 326cb. With this structure, the lens 326 may be designed to have a width gradually increasing toward the lower surface 326b thereof, thereby improving structural stability.

The first side light exit surface 326ca may have a greater radius of curvature than the second side light exit surface 326cb. This structure improves luminance uniformity through adjustment of the light path to widen light on the first side light exit surface 326ca while narrowing light on the second side emitting surface 326cb.

The radius of curvature of the first side light exit surface 326ca may be greater than a radius of curvature of the reflective surface 326a.

The radius of curvature of the first side light exit surface 326ca may be smaller than the radius of curvature of the reflective surface 326a. This structure may allow main light reflected from the reflective surface 326a to be emitted through the first side light exit surface 326ca, thereby widening the beam angle.

The second side light exit surface 326cb may have a smaller radius of curvature than the reflective surface 326a. The radius of curvature of the second side light exit surface 326cb may range from 0.2 to 0.4 times the radius of curvature of the reflective surface 326a. This structure may allow main light reflected from the reflective surface 326a to be narrowed on the second side light exit surface 326cb, thereby enabling adjustment of target light.

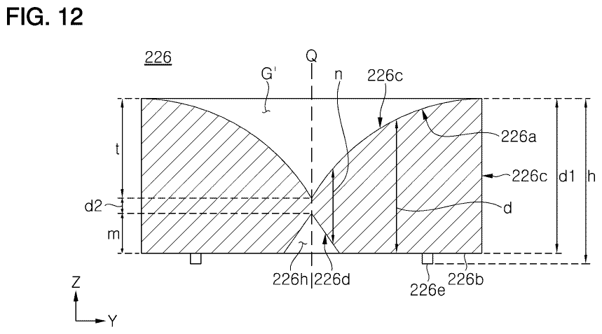

As another variant example, a lens 426 may be formed in a shape as shown in FIG. 14. Unlike the embodiments described above, no depression region G is formed on an upper surface of the lens 426 and a reflective surface 426a may be formed as a single upwardly convexly curved surface. Not only light emission but also light reflection can be achieved through the reflective surface 426a.

The reflective surface 426a may have a radius of curvature gradually increasing from a center thereof to a side thereof. The radius of curvature at the center of the reflective surface 426a may be greater than the radius of curvature at the side thereof. The reflective surface 426a may be gradually tapered toward the center thereof. The radius of curvature of the reflective surface 426a at the center thereof may be greater than a height of the lens 426. In addition, the radius of curvature of the reflective surface 426a at the center thereof may be greater than a diameter of the lens 426. With this structure, the beam angle of light can be widened laterally to form a light path over a larger area than an area in which the light source is disposed in the light emitting apparatus 10, thereby improving luminance uniformity of the light emitting apparatus 10.

A light incidence surface 426d of the lens 426 may have a shape with a curved region and may be formed by a recess 426h concavely recessed into the interior of the lens 426. A height m of the light incidence surface 426d may be less than the overall height h of the lens 426. The height m of the light incidence surface 426d may range from ½ to ⅔ of the overall height h of the lens 426. A width W3 of the light incidence surface 426d may range from ⅛ to ⅕ of the overall width W of the lens 426. The light incidence surface 426d with a high and narrow width may allow light entering the lens 426 to evenly reach the entire area inside the lens 426, thereby widening the beam angle while improving luminance uniformity over a large area in the light emitting apparatus 10.

The light incidence surface 426d may have one or more curvatures, in which the curvature in a region of the light incidence surface 426d may be greater than the largest curvature of the reflective surface 426a. In particular, the light incidence surface 426d may have the greater curvature at a center thereof, and when the light incidence surface 426d has a largest curvature at the center thereof, the light incidence surface 426d may refract incident light, which travels toward the center of the lens 426, toward a side thereof, thereby relatively decreasing luminance in a central region of the lens while increasing luminance in a lateral region thereof.

The light emitting apparatus 10 can reduce luminance difference between the center and the sides thereof through such adjustment of the directional pattern, thereby improving luminance uniformity.

In addition, the light exit surface 426c formed on the side of the lens 426 may be disposed at a height lower than half the height h of the lens 426. Further, the height K of the side light exit surface 426c formed on the side of the lens 426 may be lower than the height m of the light incidence surface 426d. This structure can suppress interference due to light emitted through the side surface of the lens and incident on another lens 426 by reducing the amount of light emitted through the side surface of the lens.

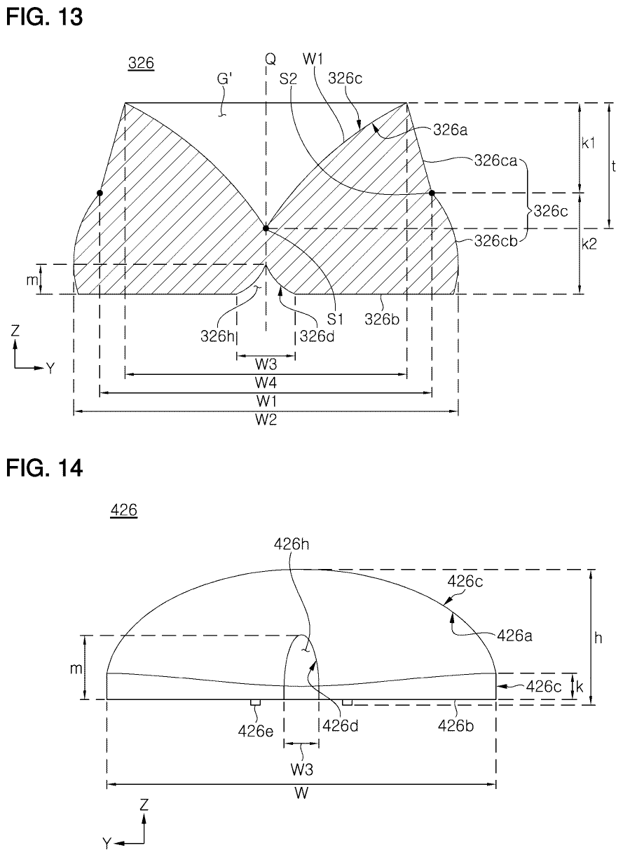

As another variant example, a lens 526 may be formed in a shape as shown in FIG. 15. Referring to FIG. 15, unlike in FIG. 14, a reflective surface 526a may include a first reflective surface 526aa and a second reflective surface 526ab through a depression region G′. The first reflective surface 526aa may be placed closer to a central region of the lens 526 than the second reflective surface 536ab.

Here, the first reflective surface 526aa and the second reflective surface 526ab may have different curvatures. The maximum curvature of the first reflective surface 526aa, which is closer to the central region than the second reflective surface 526ab, may be greater than the maximum curvature of the second reflective surface 526ab. And this may refract light incident on a center of the lens 526 toward a side thereof, thereby relatively lowering the luminance in the central region while improving luminance in the lateral region.

The light emitting apparatus 10 can reduce luminance difference between the central region and the lateral region through such adjustment of the directional pattern, thereby improving luminance uniformity.

In addition, the first reflective surface 526aa may have different curvatures in different regions, in which a region of the first reflective surface 526aa having a minimum curvature may be placed closer to the center of the lens 526 than a region of the first reflective surface 526aa having a maximum curvature. This can improve luminance uniformity by adjusting the light refraction path.

Further, a concave surface of the first reflective surface 526aa may have a lower height than a convex surface of the second reflective surface 526ab. Here, a thickness da of the lens 526 from a lower surface 526b of the lens 526 to the maximum height of the convex surface of the second reflective surface 526ab may range from 4.4 times to 5.4 times a minimum thickness db of the lens 526 formed by the recess 526d of the lens and the first reflective surface 526aa. In this structure, a main light exit surface 526c becomes a second reflective surface 526ab, thereby improving luminance in the lateral region above luminance in the central region while improving luminance uniformity of the light emitting apparatus 10.

In addition, the lower surface 526b of the lens 526 may form an inclined surface. The lower surface 526b of the lens 526 may have an inclined surface shaped such that the distance between the lens 526 and the substrate 122 gradually increases outwards from the center of the lens 526. The inclined surface of the lower surface 526b may serve to reflect light inwards. Alternatively, the inclined surface of the lower surface 526b may be shaped such that the distance between the lens 526 and the substrate 122 gradually decreases outwards from the center of the lens 526. In this structure, an outer periphery of the lens 526 has a thick thickness, thereby providing a stable structure that does not allow the lens 526 to wobble when secured.

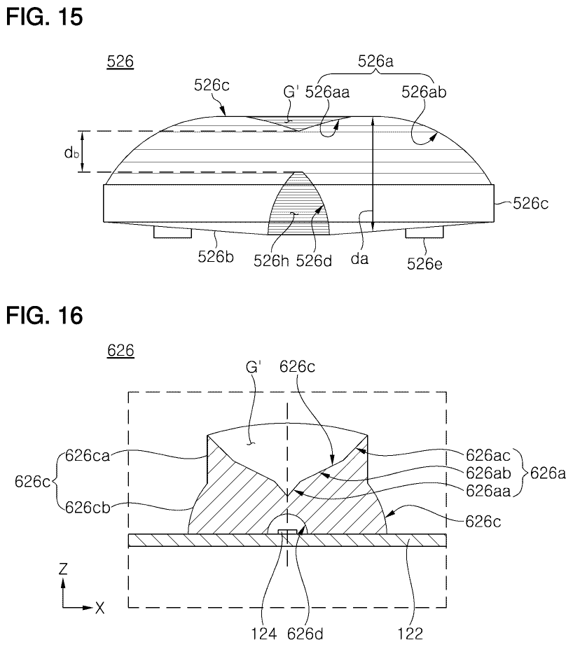

As another variant example, a lens 626 may be formed in a shape, as shown in FIG. 16. Referring to FIG. 16, an upper surface 626a of the lens 626 may include three reflective surfaces, that is, first to third reflective surfaces 626aa, 626ab, 626ac having different inclinations. The first reflective surface 626aa may refer to a surface that starts from a centerline Q of the lens 626 and is inclined upwardly toward an outer side of the lens 626. The third reflective surface 626ac may refer to a surface that starts at an edge of the lens 626 and is inclined downwardly toward the centerline Q of the lens 626. The second reflective surface 626ab may refer to a surface connecting the first reflective surface 626aa and the third reflective surface 626ac to each other. The first reflective surface 626aa may have a high inclination on the reflective surface, may partially reflect light incident thereon in an outward direction relative to the centerline Q to reduce the luminance in the central region while increasing the luminance in the lateral region, and may reduce the luminance in the central region of the light emitting apparatus 10 while increasing the luminance in the lateral region thereof to improve luminance uniformity.

The second reflective surface 626ab may have a lower inclination than the first reflective surface 626aa. The second reflective surface 626ab may partially transmit light incident thereon while partially reflecting the incident light in the lateral direction to reduce the luminance in the central region while increasing the luminance in the lateral region, may have higher luminance than the first reflective surface 626aa, and may increase the luminance outside the light emitting apparatus 10 to improve luminance uniformity. Here, an inclination of a side of the first reflective surface 625aa with respect to the center may be 20° to 30° lower than an inclination of the second reflective surface 626ab.

The third reflective surface 626ac may have a lower inclination than the first reflective surface 626aa and a higher inclination than the second reflective surface 626ab. The third reflective surface 626ac may reflect light at a lower angle than the first reflective surface 626aa to increase the amount of side light. Here, the inclination of a side of the first reflective surface 626aa with respect to a center thereof may be 10° to 19° lower than an inclination of the third reflective surface 626ac.

The first to third reflective surfaces 626ac, 626ab, 626ac may be inclined or curved surfaces. The first to third reflective surfaces 626ac, 626ab, 626ac may have different inclinations or curvatures. For example, as shown in FIG. 16, the first reflective surface 626ac may have the highest inclination and the second reflective surface 626ab may have the lowest inclination. The third reflective surface 626ac and the first side light exit surface 626ca may meet at an acute angle. The curved surfaces of the first to third reflective surfaces can provide a similar effect to the reflective surface 626a, thereby improving luminance uniformity of the light emitting apparatus 10 by reducing the luminance of central light while increasing the luminance of lateral light.

In FIG. 16, a first side light exit surface 626ca may be an inclined or vertical surface and a second side light exit surface 626cb may be a laterally convex surface. The first side light exit surface 626ca may emit light reflected from the first to third reflective surfaces 626aa, 626ab, 626ac in the lateral direction to increase luminance in a lateral region thereof by widening the beam angle. In addition, the curved region of the second side light exit surface 626cb can suppress re-incidence of light back into the lens by reducing total reflection in a light emission region, and can increase the amount of side light by reducing distortion of an emission path of light reflected from the reflective surface 626a. The second side light exit surface 626cb may have a structure in which a width of the second side light exit surface 626cb from a center thereof gradually increases towards the substrate 122. This structure allows the lens 626 to be mounted stably without tilting. In addition, a thickness of the first side light exit surface 626ca from a center thereof to an outermost edge thereof may be less than the width of the second side light exit surface 626cb. This structure allows the lens 626 to be mounted stably without tilting.

The reflective sheet 128 includes a plurality of holes 128a open to expose the plurality of lenses 126 and may have various configurations as a sheet member covering the PCB 122.

The reflective sheet 128 may be secured to the frame 110 along an outer periphery of the frame 110. In addition, the reflective sheet 128 may be coupled to the first frame region 110a of the frame 110 by a fastening pin member. As a portion of the reflective sheet 128 is coupled to the first frame region 110a by the fastening pin member, the reflective sheet 128 may partially adjoin the frame 110. With this structure, the reflective sheet 128 can prevent lifting.

As the reflective sheet 128 is coupled to the frame 110, the reflective sheet 128 may also correspond to the shape of the frame 110 and may be transformed into a rounded curved surface in outer peripheral regions of the frame 110, that is, in the second frame regions 110b, 110c. In other words, the reflective sheet 128 may include a first reflective sheet region corresponding to the first frame region 110a and a second reflective sheet region corresponding to the second frame regions 110b, 110c. The second reflective sheet region and the first frame region 110a may form an obtuse angle therebetween. This structure can improve luminance uniformity while widening the beam angle.

The reflective sheet 128 may cover a front side of the PCB 122. That is, the reflective sheet 128 may be disposed on the surface of the PCB on which the light sources 124 are mounted.

The reflective sheet 128 may have the plurality of holes 128a open to expose the lenses 126. Light emitted from the light source 124 may be emitted through the holes 128a.

The reflective sheet 128 may be a reflector configured to reflect light emitted from the lens 126 toward a front side thereof. Further, a diffusive sheet may be disposed on the front side of the reflective sheet 128 to diffuse light, and the reflective sheet 128 may reflect light reflected from the diffusive sheet back to the front side.

The reflective sheet 128 may be formed of at least one of metals or metal oxides, which are reflective materials. For example, the reflective sheet 128 may include a metal or metal oxide having high reflectivity, such as at least one of aluminum (A1), silver (Ag), gold (Au), or titanium dioxide (TiO₂), and may also include a base film, such as FET, PET, PTFE, or others.

Further, the reflective sheet 128 may be formed by coating or depositing a metal or metal oxide, or may be formed by printing an ink containing a metallic material.

The holes 128a formed in the reflective sheet 128 may be arranged at intervals in the longitudinal direction (X-axis direction) of the PCB 122. That is, the plurality of holes 128a may be arranged in the longitudinal direction (X-axis direction) of the display region A. This structure can improve luminance uniformity in the longitudinal direction.

Here, the holes 128a may be formed substantially symmetrically with respect to the centerline CL in the longitudinal direction (X-axis direction) of the display region A. This structure can improve luminance uniformity by symmetrically reflecting light.

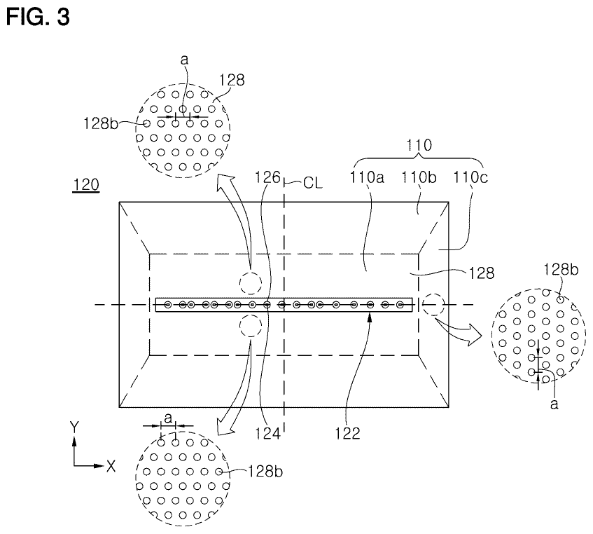

Referring to FIG. 5, the plurality of holes 128a may be disposed substantially symmetrically with respect to the centerline CL of the display region A in the longitudinal direction (X-axis direction) of the display region A.

Each of central distances M, M′ between the plurality of holes 128a may be defined as a distance between centers of adjacent holes 128a. Here, at least one of the central distances M, M′ between the plurality of holes 128a may be different from the other central distances. This structure can improve luminance uniformity by alleviating unevenness of light emitted from the light sources 124.

The central distance may be varied depending on the region within the display region A. Thus, the central distances M, M′ between the plurality of holes 128a may be different depending on the location in the display region A. By setting the central distances M, M′ differently within the display region A, luminance unevenness within the display region A can be alleviated.

The central distances M, M′ may be set to have a minimum value at an edge of the display region A. A maximum value of the central distances M, M′ may be in the range of 1.5 times to 2.1 times the minimum value. This structure may also provide an effect of compensating for deterioration in luminance at the edge of the display region A.

Referring to FIG. 5, it can be seen that the central distances M, M′ between the holes 128a are not constant from the centerline CL of the display region A to the edge EG of the display region A.

For example, the central distance M between the holes 128a at the center adjacent to the centerline CL of the display region A may be different from the central distance M′ between the holes 128a at the edge of the display region A. This structure can improve luminance uniformity.

Specifically, the central distances M, M′ between the holes 128a may be varied to gradually increase and then decrease from the centerline CL toward the edge EG of the display region A. However, it should be understood that this structure is provided by way of example and the disclosed technology is not limited thereto.

It is obvious that the variation rate of the central distances M, M′ from the centerline CL to the edge EG may also be constant or vary depending on the location in the display region A.

In addition, at least one of the holes 128a may have a different size than the other holes 128a.

Referring to FIG. 5, each of the holes 128a has a first direction length E in a first direction and a second direction length in a second direction perpendicular to the first direction, in which the first direction may coincide with the longitudinal direction (X-axis direction in the drawing) of the PCB 122.

Each of the holes 128a may be formed in a size so as to expose the lens 126 and the sizes of the holes 128a may be determined by the first direction length E and the second direction length.

For example, the holes 128a may have a common second direction length and may have different sizes by varying the first direction length E.

In addition, in a first region adjacent to the centerline CL, the first direction length E of the holes 128a may be the same as the second direction length thereof. Further, in a second region spaced apart from the first region, a first direction length E′ may be greater than the first direction length E, and the holes 128a in the second region may have a larger area than the holes 128a in the first region. Here, the second direction lengths parallel to the Y-axis direction in the second region may be the same. The first direction length E′ having a maximum value may be provided with a plurality of light sources 124. The first direction length E having a minimum value may be provided with a single light source 124. The maximum value of the first direction lengths E, E′ may range from 2.9 times to 4.1 times the minimum value thereof. This structure can improve luminance uniformity by overcoming differences in light emitted from the plurality of light sources 124.

In addition, the holes 128a in the second region may have a different area than the holes 128a in the first region to improve luminance uniformity. The maximum value of the first direction lengths E, E′ may range from 2.9 times to 4.1 times the minimum value thereof. For example, the reflective sheet can reduce difference in luminance between the first region and the second region, in which the holes 128a occupy a relatively large area.

The sizes of the holes 128a may be varied depending on the region within the display region A. That is, the sizes of the plurality of holes 128a may be different depending on the location thereof in the display region A.

As shown in FIG. 5, the sizes of the holes 128a may be variable rather than being constant from the centerline CL of the display region A to the edge EG of the display region A. By setting the sizes of the holes 128a to be different in different regions of the display region A, it is possible to improve luminance uniformity within the display region A. For example, the holes 128a may have a minimum value at the edge of the display region A. In this structure, the luminance that can be lowered at the edge of the display region A can be compensated for by the reflective sheet 128. The maximum size of the holes 128a in each region may range from 2.9 times to 4.1 times the minimum size thereof.

Each of the holes 128a may be provided with one or two lenses 126. However, it should be noted that the lenses 126 are not provided to all of the holes 128a and it is possible that a certain open hole 128a is not provided with the lens 126.

For example, the open hole 128a in the central region (in a region adjacent to the centerline CL) of the display region A may have a smaller size than the open hole 128a disposed in one of edge regions of the display region A.

Here, the sizes of the holes 128a may be varied to gradually increase and then decrease from the center of the display region A to the edge thereof, as shown in FIG. 5. However, it should be understood that this structure is provided by way of example and the disclosed technology is not limited thereto.

In some implementations, the variation rate of the sizes of the holes 128a from the centerline CL to the edge EG may be constant or vary depending on the location in the display region A.

In some implementations, the reflective sheet 128 may be formed with a plurality of punching holes 128b, as shown in FIG. 3.

Since there is difference in reflectivity between regions where the plurality of punching holes 128b are formed and other regions, luminance uniformity in the display region A can be improved through adjustment of the formation locations, number, distribution density, size, shape, or others of the punching holes 128b.

The plurality of punching holes 128b may be formed in both a first reflective sheet region corresponding to the first frame region 110a and a second reflective sheet region corresponding to the second frame regions 110b, 110bc. The punching holes 128b may be formed at a higher density in a region closer to the light source 124. The punching holes 128b may be formed at a lower density in a region farther away from the light source 124. This structure can improve luminance difference between a region close to the light source 124 and a region away from the light source 124.

In order to provide variable reflectivity, at least one of the punching holes 128b may have a different size than the other punching holes 128b. That is, the punching holes 128b may have different diameters depending on the location within the display region A. The punching holes 128b may have a smaller diameter farther away from the light source 124 to prevent luminance unevenness caused by interference between the light sources 124.

Furthermore, at least one of distances a between the punching holes 128b may be different from the distances a between the other punching holes 128b. That is, the distance a between adjacent punching holes 128b may be varied depending on the location within the display region A. A relative distance between the adjacent punching holes 128b may increase in proportion to a relative distance to the light source 124. This structure can prevent luminance unevenness caused by interference between the light sources 124.

Referring to FIG. 3, the punching holes 128b are shown as circular opening. However, it should be understood that the shape of the punching holes 128b is not limited thereto.

The light emitting unit 120 according to the disclosed technology may further include a black printing layer 129 formed in a region on the upper surface of the PCB 122.

The black printing layer 129 refers to a layer printed in a pattern on the upper surface of the PCB 122 (the surface on which the light sources 124 are mounted), and serves to absorb light through a black color such that the luminance can be adjusted. As the intensity of overlapping light of adjacent light sources 124 increases, a black region of the black printing layer 129 may have a larger area. Thus, the black region may not be formed in a region where the overlapping light of at least two adjacent light sources 124 has low intensity. Further, the black printing layer 129 may be disposed in the largest area in a region adjacent to the light sources 124.

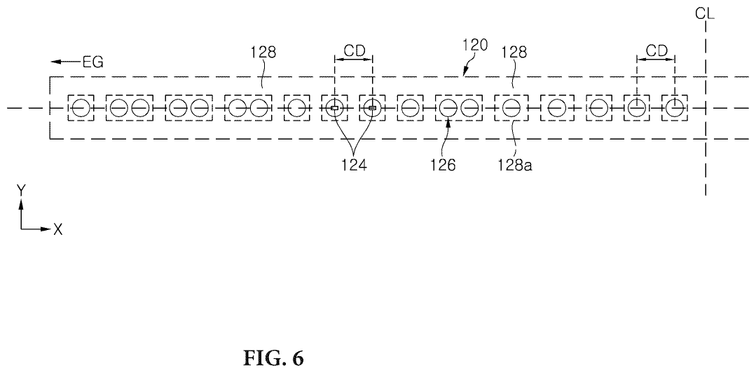

Referring to FIG. 8, the black printing layer 129 may be formed in the form of dots or lines on one surface of the PCB 122. However, it should be understood that this arrangement is provided by way of example and the shape or pattern of the black printing layer 129 is not limited thereto.

To improve luminance uniformity, the size, thickness, distribution density, or others of the black dots or black lines constituting the black printing layer 129 may be varied depending on the region in the display region. That is, since the black printing layer 129 is partially exposed through the holes 128a of the reflective sheet 128, light emitted through the lens 126 may be absorbed differently in different regions, thereby improving luminance uniformity in the display region A.

By appropriately combining the shape of the anisotropic lens 126, the central distances CD between the light sources 124, the sizes of the holes 128a, the central distances M between the holes 128a, the size/spacing/distribution/location of the punching holes 128b, the black printing layer 129, or others, the disclosed technology can manage luminance uniformity at a certain level or more such that the first luminance A1 at the edge of the display region A ranges from 0.4 times to 0.7 times the second luminance A2 at the center of the display region A.

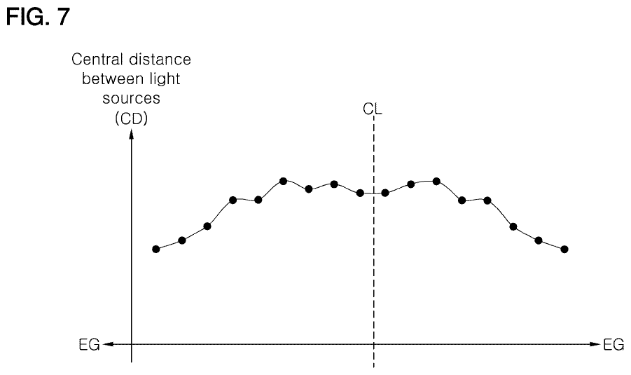

Although FIG. 3 illustrates an example in which the light emitting unit 120 includes a single PCB 122, it should be understood that the disclosed technology is not limited thereto and, as shown in FIG. 9, a plurality of PCBs 122 may be included.

Since the longitudinal direction of the PCB 122 is parallel to the longitudinal direction (X-axis direction) of the display region A, the plurality of PCBs 122 may be arranged at regular intervals in the longitudinal direction (Y-axis direction) of the display region A.

Although some exemplary embodiments have been described above with reference to the accompanying drawings, it should be understood that various modifications and changes can be made by those skilled in the art or by a person having ordinary knowledge in the art.

Only a few examples and implementations are disclosed. Variations, modifications, and enhancements to the described examples and implementations and other implementations can be made based on what is disclosed.

1. A light emitting apparatus, comprising:
a frame; and
a light emitting module disposed on the frame,
wherein the light emitting module includes a printed circuit board (PCB), light sources disposed on the PCB, a plurality of lenses disposed on the light sources, and a reflective sheet disposed on the PCB and including a plurality of holes configured to expose the light sources,
wherein a light is emitted from the light emitting module to a display region including a central region, a vertex region, a first intermediate region between the central region and the vertex region,
wherein the first intermediate region has a first luminance lower than a second luminance in the central region of the display region.

2. The light emitting apparatus according to claim 1, wherein the first luminance has a value in a range of 0.7 times to 0.9 times the second luminance.

3. The light emitting apparatus according to claim 1, wherein the first luminance has a higher value than a third luminance in the vertex region.

4. The light emitting apparatus according to claim 1, wherein the display region further includes a second intermediate region between a side of the display region and the central region of the display region and the second intermediate region has a fourth luminance lower than the second luminance in the central region of the display region.

5. The light emitting apparatus according to claim 4, wherein the fourth luminance has a value in a range of 0.7 times to 0.9 times the second luminance.

6. The light emitting apparatus according to claim 5, wherein the fourth luminance has a higher value than a third luminance in the vertex region.

7. The light emitting apparatus according to claim 1, wherein at least one of distances between two adjacent ones of the light sources is different from remaining distances.

8. The light emitting apparatus according to claim 1, wherein at least one of the plurality of holes has a different size from remaining holes.

9. The light emitting apparatus according to claim 1, wherein the reflective sheet includes a plurality of punching holes, at least one of the plurality of punching holes having a different size from remaining punching holes.

10. The light emitting apparatus according to claim 1, wherein the light emitting module further comprises a black printing layer disposed in a region on an upper surface of the PCB.

11. A light emitting apparatus, comprising:
a frame; and
a light emitting module disposed on the frame, wherein the light emitting module includes a printed circuit board (PCB), a plurality of light sources disposed on the PCB, a plurality of lenses coupled to the plurality of light sources; a reflective sheet disposed on the PCB and including a plurality of holes configured to expose the plurality of light sources; and
a display region configured to receive light emitted from the light emitting module,
wherein the display region has a long side in a first direction and a short side in a second direction perpendicular to the first direction, and the plurality of lenses have a short axis in a direction parallel to the first direction and a long axis in a direction parallel to the second direction.

12. The light emitting apparatus according to claim 11, wherein a length of a lens of the plurality of lenses along the long axis is greater than or substantially equal to twice a length of the lens along the short axis.

13. The light emitting apparatus according to claim 11, wherein at least one of the plurality of lenses has a depression region that is substantially bisymmetrically with respect to a center line of the at least one of the plurality of lenses.

14. The light emitting apparatus according to claim 13, wherein the depression region has a region with an inclination that gradually decreases as a distance from the center line increases.

15. The light emitting apparatus according to claim 11, wherein the display region includes a central region, a vertex region, a first intermediate region between the central region and the vertex region, and wherein the first intermediate region has a first luminance lower than a second luminance in the central region of the display region.

16. The light emitting apparatus according to claim 11, wherein the display region further includes a second intermediate region between a side of the display region and a central region of the display region and the second intermediate region has a fourth luminance lower than a second luminance in the central region of the display region.

17. A light emitting apparatus, comprising:
a frame;
a light emitting module disposed on the frame, wherein the light emitting module includes a PCB, a plurality of light sources disposed on the PCB, a plurality of lenses disposed on the plurality of light sources, and a reflective sheet disposed on the PCB and having a plurality of holes configured to expose the plurality of light sources; and
a display region configured to receive light emitted from the light emitting module,
wherein the display region has a long side in a first direction and a short side in a second direction crossing the first direction, and
wherein the plurality of lenses includes a reflective surface having an inclination that gradually decreases as a distance from a center of a lens increases.

18. The light emitting apparatus according to claim 17, wherein at least one of the plurality of lenses includes a depression region disposed on a central region of the lens.

19. The light emitting apparatus according to claim 18, wherein the reflective surface and the depression region are substantially bisymmetrical with respect to the center of the lens.

20. The light emitting apparatus according to claim 18, wherein an outer peripheral region of the depression region includes a planar surface.
